(19) United States
(12) Patent Application Publication
(10) Pub. No.: US 2005/0213995 A1
(43) Pub. Date: Sep. 29, 2005

(54) Low power and low jitter optical receiver for fiber optic communication link

(76) Inventors: Myunghee Lee, San Jose, CA (US); Ronald Kaneshiro, Los Altos, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/809,971

(22) Filed: Mar. 26, 2004

(51) Int. Cl. H04B 10/00

(52) U.S. Cl. 398/208

(57) ABSTRACT

An optical receiver uses a clock data recovery block to improve the jitter and the power consumption of the optical receiver. The optical receiver includes a photodetector for receiving an optical signal and generating a corresponding current signal, a gain stage coupled to the photodetector for receiving the corresponding current signal and converting it to a corresponding voltage signal, and a clock data recovery circuit coupled to the gain stage for receiving the corresponding voltage signal, extracting clock information from the corresponding voltage signal, and regenerating the corresponding voltage signal to reduce jitter.

### BACKGROUND OF THE INVENTION

An optical receiver is used in fiber optic networks to detect optical signals and convert them into electrical signals for processing. As the data rates of the optical networks increase, the optical receiver must also operate at faster speeds. Generally, at the higher data rates, the power consumption and the jitter (time-based signal variations) in the optical receiver increase as well. Therefore, it is desirable to decrease the power consumed by the optical receiver, as well as the jitter associated with the optical receiver.

A typical prior art optical receiver 11, as shown in FIG. 1, generally includes a photodetector 13, a transimpedance amplifier (“TIA”) 15, and a post-amplifier 17. The photodetector 13 is an optoelectronic transducer (e.g. a photodiode or other light-detecting device) that converts the light energy from an optical signal into an electrical current signal. The TIA 15 is a low-noise gain stage that converts the electrical current signal into a corresponding voltage signal. Generally the TIA 15 is designed to have high bandwidth to be responsive to the high data rates of the optical signals. The higher bandwidth of the TIA 15 translates into a lower gain, however, so the output of the TIA 15 needs to be amplified further by the post-amplifier 17. Typically the post-amplifier 17 is a limited amplifier that has automatic gain control, since the strength of the corresponding voltage signal (the input to the post-amplifier) may vary considerably. The combination of the conventional TIA 15 and a post-amplifier 17 consumes a lot of power and has poor jitter performance, especially at higher data rates (e.g. above 5 gigabits per second).

### SUMMARY OF THE INVENTION

In a preferred embodiment of the present invention, an optical receiver uses a clock data recovery block (“CDR”) instead of a post-amplifier. The CDR can tolerate more incoming jitter than a post-amplifier due to its regenerative capabilities. The CDR can also be operated at lower power supplies than a post-amplifier because it can use processes with smaller geometries. Consequently, the CDR improves the jitter and the power consumption of the optical receiver. The CDR also reduces the jitter requirement for the TIA, so the TIA can have a narrower bandwidth and a higher gain than in the prior art, which significantly reduces the power consumption of the TIA.

In an alternate embodiment of the present invention, an optical receiver uses a compensation circuit to compensate the frequency response of the TIA. Consequently, the required bandwidth for the TIA can be reduced because the compensation circuit can fill in at the higher frequencies for a narrower TIA bandwidth.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 illustrates a typical prior art optical receiver.

FIG. 2 illustrates an optical receiver according to a preferred embodiment of the present invention.

FIG. 3 illustrates an exemplary clock data recovery circuit that may be used with the present invention.

FIG. 4 illustrates an alternate embodiment for an optical receiver according to the present invention.

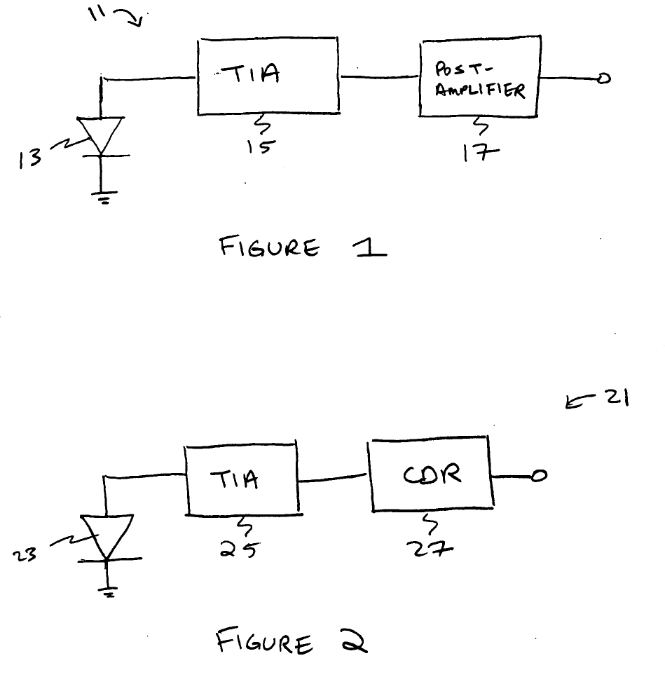

### DETAILED DESCRIPTION

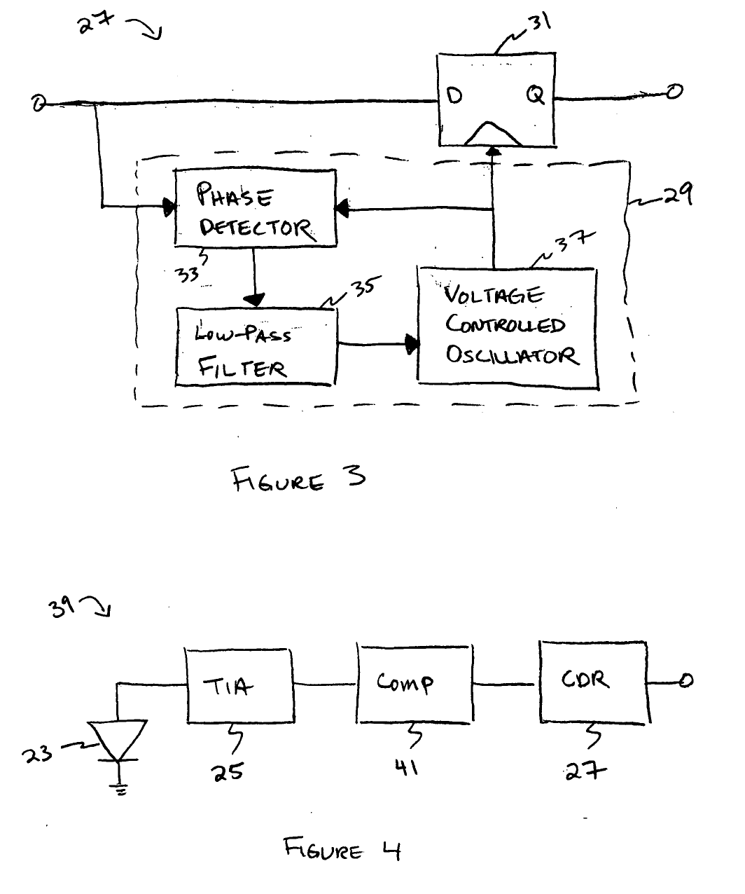

FIG. 2 shows a preferred embodiment of an optical receiver 21, made in accordance with the teachings of the present invention. The optical receiver 21 includes a photodetector 23, a TIA 25, and a clock data recovery circuit (“CDR”) 27. The photodetector 23 converts light energy into an electrical current signal. The TIA 25 is a gain stage that converts the electrical current signal into a voltage signal, which is the input to the CDR 27. The CDR 27 recovers the clock information from the voltage signal, then regenerates and synchronizes the voltage signal according to the recovered clock to reduce jitter.

Due to its regenerative capabilities, the CDR 27 can tolerate more incoming jitter at its input than a post-amplifier 17. Consequently, the bandwidth of the TIA 25 can be reduced in the present invention. Since the TIA 25 has a reduced bandwidth, it can also have a higher gain and therefore a post-amplifier is no longer needed. Removing the post-amplifier reduces the overall power consumption of the optical receiver 21. The CDR 27 can also be operated at a lower power supply than a post-amplifier because it can use processes with smaller geometries and therefore provides additional power savings. The CDR 27 can be implemented on the same chip as the TIA 25.

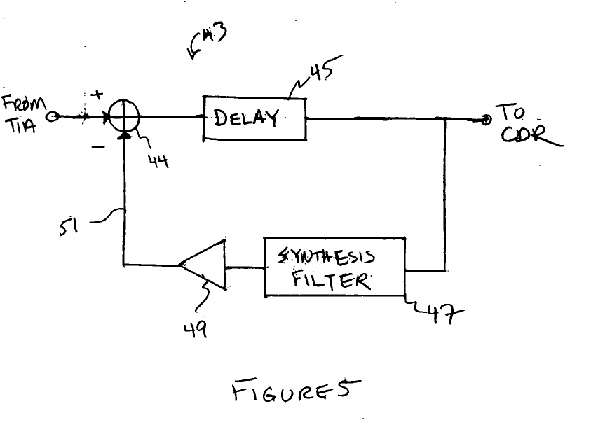

The CDR 27 is a common functional block well known to those who are skilled in the art. FIG. 3 illustrates a basic block diagram of an exemplary CDR circuit 27, although there are many other implementations of a CDR circuit that may be utilized. The exemplary CDR 27 includes a phase-locked loop (“PLL”) 29 to recover the clock information from the input signal. The recovered clock is used to retime the data using a decision circuit such as a D flip-flop 31.

The PLL 29 includes a phase detector 33, a low-pass filter 35, and a voltage controlled oscillator (“VCO”) 37. The phase detector 33 detects the difference in phase between the input signal and the output of the VCO 37. The output of the phase detector 33 is a signal that indicates the difference in phase. The low-pass filter 35 filters the high frequency components from the output of the phase detector 33. The filtered signal controls the VCO 37. The output of the VCO 37 is the recovered clock, which is used to clock the D flip-flop 31 for retiming the input signal.

FIG. 4 illustrates an alternate embodiment for an optical receiver 39 according to the present invention. The optical receiver 39 uses a compensation circuit 41 to compensate the higher frequencies that are attenuated or distorted by the TIA 25, prior to processing by the CDR 27. The effect of the compensation circuit 41 is to equalize the frequency response of the optical receiver 39 within the frequency range of interest. Consequently, the bandwidth required of the TIA 25 can be reduced significantly, to as little as one quarter of the bandwidth of a TIA in a conventional optical receiver. For example, if the optical receiver has an 8 gigahertz bandwidth, the TIA 25 may be designed with a bandwidth of only 2 gigahertz—the compensation circuit 41 compensates for the remaining 6 gigahertz of bandwidth.

In one embodiment, the compensation circuit 41 has a frequency response that is approximately the inverse of the frequency response of the TIA 25 within the frequency range of interest. For example, if the TIA 25 behaves like a high gain, low pass filter, the compensation circuit 41 should have a frequency response that is the inverse of a high gain, low-pass filter. The compensation circuit 41 can be implemented as a digital or analog circuit. Using a compensation circuit 41 allows one to make a less expensive and less complex TIA 25 since the bandwidth of the TIA 25 can be reduced. The TIA 25 & the compensation circuit 41 can both be formed on a single chip.

In one embodiment, the compensation circuit 41 is an equalizer. Equalizers are well known in the art and are widely used. FIG. 5 shows one possible implementation of an equalizer 43 for the present invention. The equalizer 43 includes an adder 44, a delay element 45, a synthesis filter 47, and a buffer 49. The delay element 45 delays the signal from the TIA 25 and sends it to the synthesis filter 47. The synthesis filter 47 may be a single filter or a combination of filters, such as a filter bank. The output of the synthesis filter 47 is buffered by a buffer 49 to produce a compensating signal 51. The synthesis filter 47 is selected such that the compensating signal 51, when added to the signal from the TIA by adder 49, results in a compensated signal for output to the CDR. One possible design for the synthesis filter 47 is described in more detail in pending U.S. patent application Ser. No. 10/283,566, “Adaptive Decoder For Skin Effect Limited Signals”. There are various other implementations for an equalizer that would also be suitable for use in the present invention.

Although the present invention has been described in detail with reference to particular preferred embodiments, persons possessing ordinary skill in the art to which this invention pertains will appreciate that various modifications and enhancements may be made without departing from the spirit and scope of the claims that follow. For example, the present invention is applicable to both single and multi-channel optical receivers.

1. An optical receiver, comprising:
a photodetector receiving an optical signal and generating a corresponding current signal;
a gain stage coupled to the photodetector receiving the corresponding current signal and converting it to a corresponding voltage signal; and
a clock data recovery (CDR) circuit directly coupled to the gain stage receiving the corresponding voltage signal, extracting clock information from the corresponding voltage signal, and regenerating the corresponding voltage signal to reduce jitter.

2. An optical receiver as in claim 1, wherein the gain stage is a transimpedance amplifier circuit having a first frequency response.

3. An optical receiver as in claim 2, wherein the transimpedance amplifier circuit and the CDR circuit are formed on a single chip.

4. An optical receiver as in claim 2, further comprising:
a compensation circuit interposing the transimpedance amplifier circuit and the CDR circuit, the compensation circuit having a second frequency response that is approximately the inverse of the first frequency response of the transimpedance amplifier circuit.

5. An optical receiver as in claim 2, further comprising:
a compensation circuit interposing the transimpedance amplifier circuit and the CDR circuit, wherein the compensation circuit is an equalizer.

6. An optical receiver as in claim 5, wherein the equalizer includes a synthesis filter.

7. A method for receiving an optical signal, comprising:
converting the optical signal into a corresponding current signal;
converting the corresponding current signal into a corresponding voltage signal with a gain stage;
extracting clock information from the corresponding voltage signal; and
regenerating the corresponding voltage signal to reduce jitter.

8. A method as in claim 7, further comprising:
compensating for attenuation in the corresponding voltage signal, prior to extracting clock information.

9. A method as in claim 8, wherein the gain stage is a transimpedance amplifier having a first frequency response.

10. A method as in claim 9, wherein compensating for attenuation is performed by a compensation circuit having a second frequency response that is approximately the inverse of the first frequency response.

11. A method as in claim 7, wherein the corresponding voltage signal is equalized, prior to extracting clock information.
